(19) United States
(12) Patent Application Publication
(10) Pub. No.: US 2014/0152250 A1
(43) Pub. Date: Jun. 5, 2014

(54) SYSTEM AND METHOD FOR CONTROLLING OUTPUT POWER IN A CONTACTLESS POWER TRANSFER SYSTEM

(71) Applicants: Pradeep Vijayan, Bangalore (IN); Shahil Shah, Troy, NY (US)

(72) Inventors: Pradeep Vijayan, Bangalore (IN); Shahil Shah, Troy, NY (US)

(73) Assignee: General Electric Company, Schenectady, NY (US)

(21) Appl. No.: 14/088,955

(22) Filed: Nov. 25, 2013

(30) Foreign Application Priority Data
Nov. 30, 2012 (IN) 5015/CHE/2012

(51) Int. Cl. H02M 3/335; H01F 38/14; H02J 7/02

(52) U.S. Cl. CPC H02M 3/3353; H02J 7/025; H01F 38/14
USPC 320/108; 363/17; 307/104

(57) ABSTRACT

A power conversion system including a power source configured to provide input power is disclosed. The power conversion system also includes a first power converter comprising switches configured to convert the input power to an intermediate converted power. The power conversion system further includes a controller configured to control the switches based on an asymmetrical voltage cancellation mode wherein the controller is configured to operate the first power converter at a fixed operating frequency, maintain a zero voltage switching mode and control a duty cycle of the switches. The power conversion system also includes a contactless power transfer system configured to transmit the intermediate converted power to a load wherein the load is coupled to a second power converter that converts the intermediate converted power to an output power wherein an output voltage of the output power is controlled by the controller based on the asymmetrical voltage cancellation mode.

### BACKGROUND

Embodiments of the invention generally relate to contactless power transfer systems and more particularly to a system and method for controlling an output power in the contactless power transfer systems.

Power transfer systems are used to transfer power from a power source to a load through various techniques. Based on the techniques, the power transfer systems can be broadly classified under common power transfer systems that use contacts such as wires to transfer power and contactless power transfer systems that transfer power wirelessly.

Contactless power transfer is achieved by using different approaches such as inductive coupling and resonator coupling. The resonator coupling approach uses resonators that are placed at a distance from each other and transfer power from one resonator to another when the resonators are excited at a particular frequency. The resonators generate a magnetic field upon excitation and transmit the power through the magnetic field to the load.

Generally, the power transfer systems are coupled to a power converter that converts an input power to a transferable power which is transmitted to the load. The power converter includes switches which are operated at different switching frequencies to convert the input power to the transferable power. In common power transfer systems which transfer power through contacts, the steady state voltage gain is a monotonic function of the switching frequency of the power converter and therefore, an output power at the load of the common power transfer systems is controlled by controlling the switching frequency of the power converter through a variable frequency control mechanism.

However, due to a multi-resonant behavior of the contactless power transfer system, the steady state voltage gain of the contactless power transfer system is not monotonic over a range of operating frequencies and therefore, using the variable frequency control mechanism to control the output power in the contactless power transfer system leads to complexity and unreliability.

Hence, there is a need for an improved system to address the aforementioned issues.

### BRIEF DESCRIPTION

Briefly, in accordance with one embodiment, a power conversion system is provided. The power conversion system includes a power source configured to provide input power. The power conversion system also includes a first power converter comprising switches configured to convert the input power to an intermediate converted power. The power conversion system further includes a controller configured to control the switches of the first power converter based on an asymmetrical voltage cancellation mode wherein the controller is configured to operate the first power converter at a fixed operating frequency, maintain a zero voltage switching mode and control a duty cycle of the switches of the first power converter. The power conversion system also includes a contactless power transfer system configured to transmit the intermediate converted power to a load. The power conversion system further includes a second power converter coupled to the load for converting the intermediate converted power to an output power wherein an output voltage of the output power is controlled by the controller based on the asymmetrical voltage cancellation mode.

In another embodiment, a method for controlling voltage of an output power of the power conversion system is provided. The method includes identifying a fixed operating frequency based on a load coupled to a power conversion system. The method also includes switching an input power based on an asymmetrical voltage cancellation mode at the fixed operating frequency for providing an output power. The method further includes transmitting the output power to the load using a contactless power transfer system.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of a power conversion system including a contactless power transfer system and a controller configured to control switches of a first power converter based on an asymmetrical voltage cancellation mode in accordance with an embodiment of the invention.

FIG. 2 is a block diagram representation of a two coil contactless power transfer system provided in the power conversion system of FIG. 1 in accordance with an embodiment of the invention.

FIG. 3 is a block diagram representation of a three coil contactless power transfer system provided in the power conversion system of FIG. 1 in accordance with an embodiment of the invention.

FIG. 4 is a block diagram representation of a four coil contactless power transfer system provided in the power conversion system of FIG. 1 in accordance with an embodiment of the invention.

FIG. 5 is a schematic representation of a specific embodiment of the power conversion system of FIG. 1 including a DC power source, a DC-AC power converter and an AC-DC power converter in accordance with an embodiment of the invention.

FIG. 6 is a graphical representation of waveforms depicting the duty cycles of the switches of the DC-AC power converter of FIG. 5 in accordance with an embodiment of the invention.

FIG. 7 is a graphical representation of a relationship of a phase angle between a fundamental component of the voltage and the switched component of the voltage in degrees and gain in the DC-AC power converter of FIG. 5 in accordance with an embodiment of the invention.

FIG. 8 is a schematic representation of another embodiment of the power conversion system of FIG. 5 including multiple predefined loads in accordance with an embodiment of the invention.

FIG. 9 is a block diagram representation of another embodiment of the power conversion system of FIG. 1 including an adaptive controller coupled to a power source and the controller in accordance with an embodiment of the invention.

FIG. 10 is a flow chart representing steps involved in a method for controlling an output voltage of an output power of the power conversion system in accordance with an embodiment of the invention.

### DETAILED DESCRIPTION

Embodiments of the present invention include a power conversion system that includes a power source configured to provide input power. The power conversion system also includes a first power converter comprising switches that convert the input power to an intermediate converted power. The power conversion system further includes a controller that controls the switches of the first power converter based on an asymmetrical voltage cancellation mode wherein the controller is configured to operate the first power converter at a fixed operating frequency, maintain a zero voltage switching mode during operation and control a duty cycle of the switches of the first power converter. The power conversion system also includes a contactless power transfer system that transmits the intermediate converted power to a load which is coupled to a second power converter which converts the intermediate converted power to an output power wherein an output voltage of the output power is controlled by the controller based on the asymmetrical voltage cancellation mode.

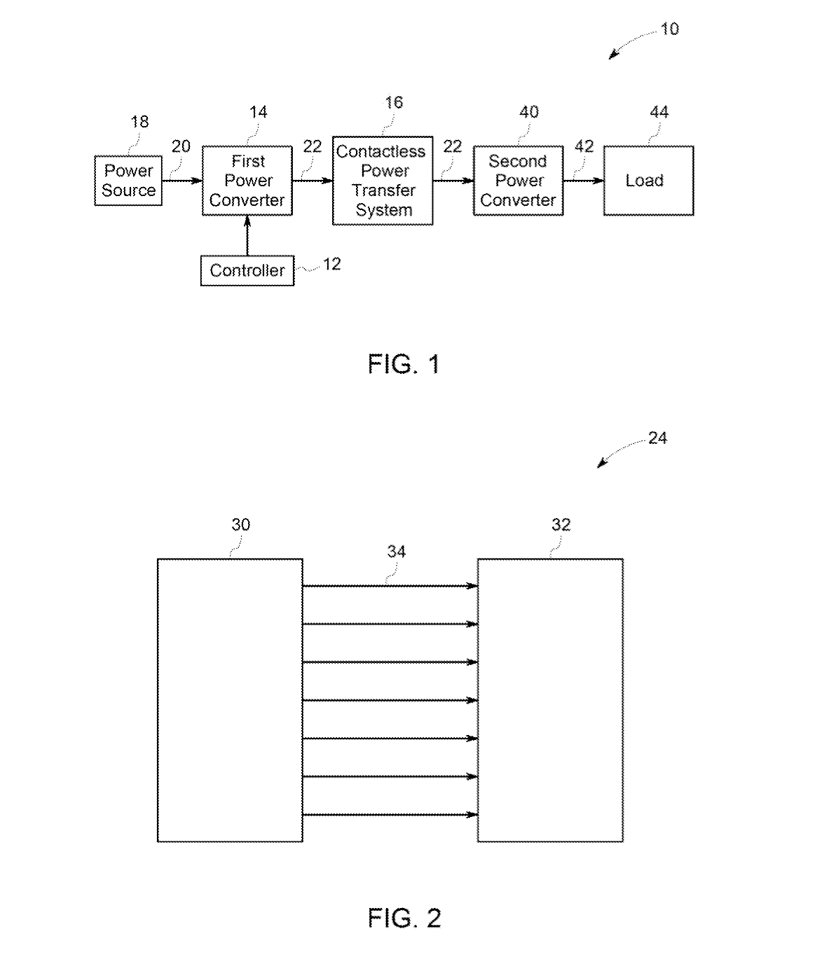

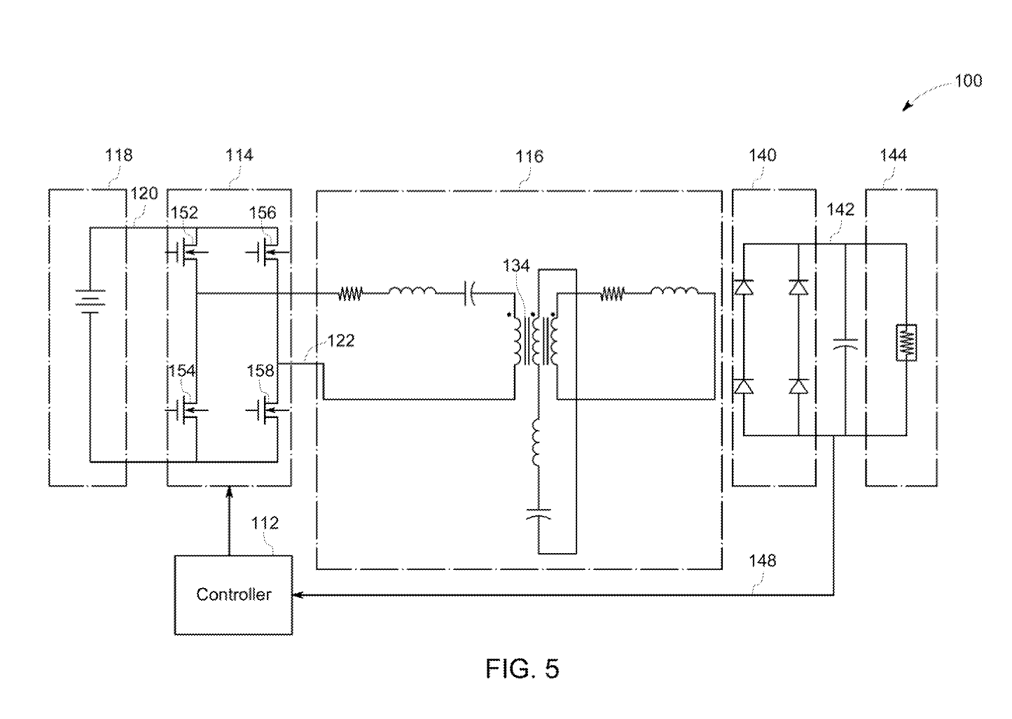

FIG. 1 is a block diagram representation of a power conversion system 10 including a controller 12 configured to control switches (FIG. 5) of a first power converter 14 based on an asymmetrical voltage cancellation mode and a contactless power transfer system 16 in accordance with an embodiment of the invention. The power conversion system 10 includes a power source 18 that provides an input power 20 to the first power converter 14. The first power converter 14 converts the input power 20 to an “intermediate converted power 22” which is defined as an output power of the first power converter 14 and is transferred to the contactless power transfer system 16. In specific embodiments, the contactless power transfer system 16 includes a two coil contactless power transfer system 24, a three coil contactless power transfer system 26 or a four coil contactless power transfer system 28 as described in FIGS. 2-4 below.

FIG. 2 is a block diagram representation of the two coil contactless power transfer system 24 including a primary coil 30 and a secondary coil 32 wherein the primary coil 30 generates a magnetic field 34 upon excitation by the intermediate converted power 22 provided by the first power converter 14 (FIG. 1). The magnetic field 34 is focused to the secondary coil 32 that receives the magnetic field 34 and converts the magnetic field 34 to a power representative of the intermediate converted power 22.

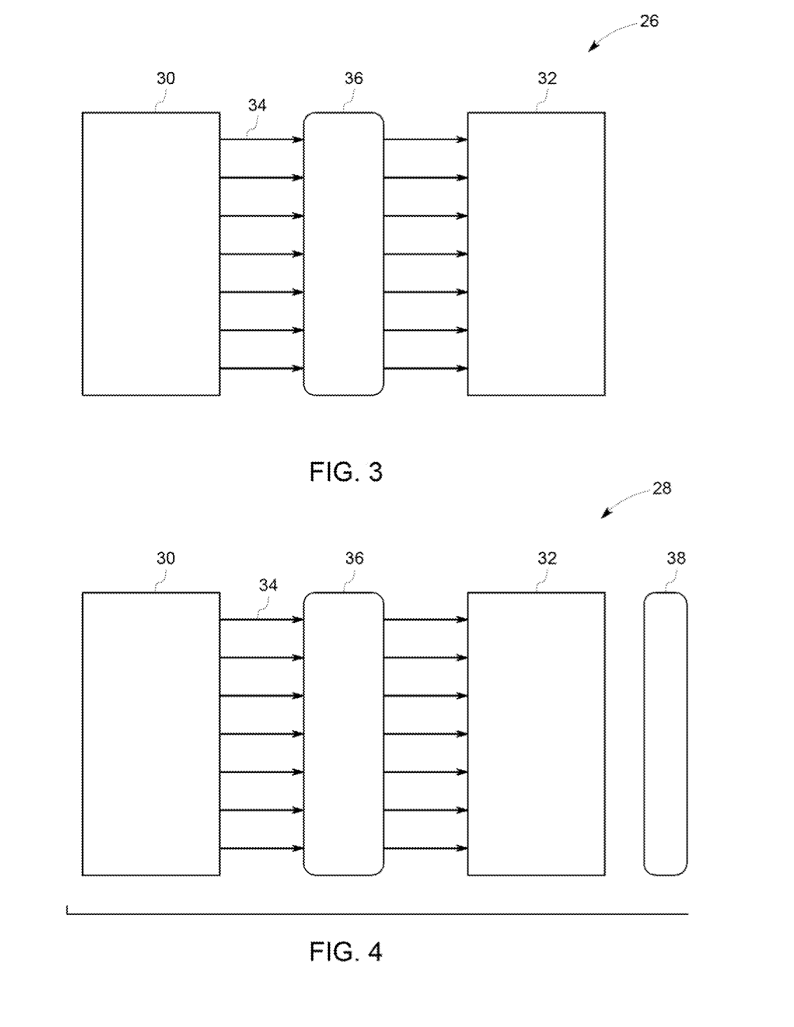

FIG. 3 represents the three coil contactless power transfer system 26 wherein a field focusing element 36 is situated between the primary coil 30 and the secondary coil 32. The intermediate converted power 22 excites the primary coil 30 and the field focusing coil 36 simultaneously and the magnetic field 34 generated by the primary coil 30 is focused to the secondary coil 32 via the field focusing element 36. In one embodiment, the field focusing element 36 includes a plurality of resonators arranged in an array which are excited by the intermediate converted power 22 simultaneously. The field focusing element 36 enhances the coupling between the primary coil 30 and the secondary coil 32.

FIG. 4 is a block diagram representation of the four coil contactless power transfer system 28 which includes a compensation coil 38 in addition to the primary coil 30, the secondary coil 32 and the field focusing element 36. The compensation coil 38 has a resonance frequency different from a resonance frequency of the field focusing element 36 for matching an impedance of the four coil contactless power transfer system 28 and compensates for a change in phase resulting from a misalignment of the four coil contactless power transfer system 28.

Referring back to FIG. 1, the first power converter 14 includes switches (FIG. 5) that are controlled by the controller 12 to provide the intermediate converted power 22 which is transferred through the contactless power transfer system 16 to a second power converter 40 via the magnetic field 34. The second power converter 40 receives the intermediate converted power 22 from the contactless power transfer system 16 and converts the intermediate convened power 22 to an output power 42. The second power converter 40 transmits the output power 42 to a load 44 coupled to the second power converter 40 for further use. The power conversion system 10 and its operation is described in greater detail with respect to an embodiment of the power conversion system 10 as discussed below in FIG. 5 below.

FIG. 5 is a block diagram representation of a specific embodiment 100 of the power conversion system 10 of FIG. 1 including a DC power source 118, a DC-AC power converter 114 and an AC-DC power converter 140 in accordance with an embodiment of the invention. The DC power source 118 provides DC power 120 to the DC-AC power converter 114 which converts the DC power 120 to AC power 122. The AC power 122 is transferred to a contactless power transfer system 116 that transmits the AC power 122 to an AC-DC power converter 140 via a magnetic field 134. The AC-DC power converter 140 receives the AC power 122 and converts the AC power 122 to an output DC power 142. In one embodiment, the DC power source 118 may be derived from an AC source, such as a wall outlet, by passing the power through an additional AC-DC power converter (not shown). The additional AC-DC power converter can be a simple diode bridge rectifier or an active rectifier capable of maintaining low input current distortion and unity power factor.

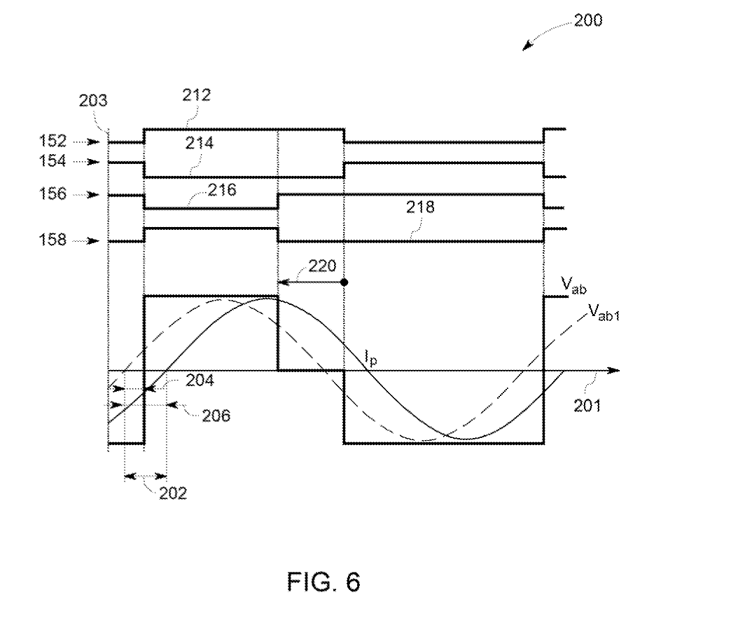

Since the contactless power transfer system 116 includes multiple resonators, the contactless power transfer system 116 inherently exhibits a multi resonant behavior due to which controlling the output voltage of the output DC power 142 based on variable frequency control results in complexity and unreliability. Therefore, the DC-AC power converter 114 is coupled to a controller 112 that controls the switches 152, 154, 156, 158 of the DC-AC power converter 114 based on the asymmetrical voltage cancellation mode to control the output DC voltage as shown in FIG. 6 below.

FIG. 6 is a graphical representation of waveforms 200 representing gate signals and the output DC voltage of the output DC power during operation in the asymmetrical voltage cancellation mode in accordance with an embodiment of the invention. X axis 201 denotes time in seconds or radians and Y axis 203 denotes the magnitude of voltage and current. The controller 112 (FIG. 5) is configured to control the switches 152, 154, 156, 158 (FIG. 5) based on the asymmetrical voltage cancellation mode wherein the controller 112 is configured to operate the DC-AC power converter 114 at a fixed operating frequency, maintain a zero voltage switching mode during operation and control a duty cycle of the switches 152, 154, 156, 158 of the DC-AC power converter 114. In any given situation, upon initialization of the operation of the power conversion system 100, the power conversion system 100 conducts a frequency sweep including the load 144 during which the controller 112 evaluates a zero voltage switching mode at multiple frequencies for the respective load 144.

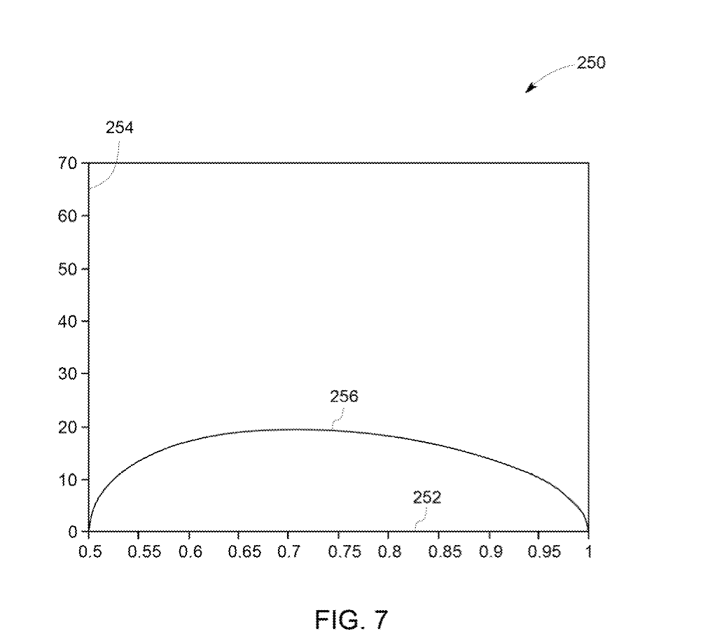

The zero voltage switching condition is achieved where Δφ=φ−φv1>0 wherein φ₁ is the phase angle 202 between the fundamental component of current Iₚ and the fundamental component of voltage (V_{ab1}) of the AC power, φᵥ₁ is the phase angle 204 between the fundamental component of the voltage (V_{ab1}) and the switched component of the voltage (V_{ab}) and Δφ is the difference 206 between the φ₁ and φᵥ₁ which is always greater than zero to ensure a zero voltage switching condition. The controller 112 evaluates the zero voltage condition for the given load 144 and subsequently selects the frequency at which the zero voltage condition is met for the entire operation of the DC-AC power converter 114. The controller 112 uses the selected frequency as the fixed frequency for switching the switches 152, 154, 156, 158 of the DC-AC power converter 114 to provide the AC power 122. In one embodiment, the controller 112 may by default select a frequency at which the phase angle 204 (φᵥ₁) between the fundamental component of the voltage and the switched component of the voltage of the AC power 112 is more than twenty degrees irrespective of the load because a maximum phase angle (φᵥ₁ₘₐₓ) between the fundamental component of the voltage and the switched component of the voltage does not exceed twenty degrees for an entire range of gain during the asymmetrical voltage cancellation mode. The phase angle 204 (φ_{v1) between the fundamental component of the voltage and the switched component of the voltage of the AC power 112 does not depend on load 144, however, the phase angle 202 (φ}₁) between the fundamental component of current Iₚ and the fundamental component of voltage (V_{ab1}) of the AC power depends on the value of the load resistance. The gain of the AC-DC power converter is a function of the load and the gain increases as the load decreases. Therefore, as long as the phase angle (φ₁) between the fundamental component of voltage and the fundamental component of current is greater than twenty degrees, the fundamental component of current (Iₚ) will cross zero after the fundamental component of voltage (V_{ab}) has crossed zero which would ensure the zero voltage switching condition. Hence, the zero voltage switching condition is ensured over the entire operation of the DC-AC power converter 114 for any give load as shown in FIG. 7.

As illustrated, FIG. 7 depicts a graph 250 including an X-axis 252 that represents the gain and a Y-axis 254 that represents the phase angle 204 (ωᵥ₁) between the fundamental component of the voltage and the switched component of the voltage in degrees. Curve 256 represents a change in the phase angle 204 (φᵥ₁) based on the gain in the power conversion system 100. Clearly, the phase angle 204 (φᵥ₁) does not exceed twenty degrees for a range of gain values between half (0.5) to one (1). Therefore, any phase angle 204 (φᵥ₁) which is more than twenty degrees will ensure the zero voltage switching mode for the DC-AC power converter 114.

Referring again to FIG. 5, the output DC power 142 at the AC-DC power converter 140 is fed to the load 144. In a specific embodiment, the load 144 comprises a battery. In a more specific embodiment, the battery is situated in an electric vehicle. A signal representative of the output DC voltage 142 at the load 144 is transmitted to the controller 112 via a feedback loop 148 and the controller 112 in order to provide a constant voltage to the load 144 controls the duty cycle of the switches 152-158 of the DC-AC power converter 114 based on the asymmetrical voltage cancellation mode as described in FIG. 6.

Referring back and in continuation to the description of FIG. 6 above, the phase angle 202 (φ₁) between the fundamental component of current Iₚ and the fundamental component of voltage (V_{ab1}) of the AC power 122 depends on circuit parameters and the operating switching frequency but is independent of the duty cycle. Curves 212, 214, 216, 218 represent the duty cycles of switches 152, 154, 156, 158 (FIG. 5) of the DC-AC power converter 114 respectively. The duty cycles of the switches 152-158 are controlled by controlling a firing angle (α) 220 which is denoted by the equation

$$ϕ v 1 = {tan}^{- 1} \frac{sin α}{3 + cos α}$$

From the above mentioned equation it is understood that the firing angle (α) 220 can be varied from zero (0) to pie (π) and therefore, the output DC voltage can be regulated to fifty percent (50%) while maintaining the zero voltage switching mode as required in the power conversion system 100. Therefore, the controller 112 controls the switches 152-158 of the DC-AC power converter 114 such that the DC-AC power converter 114 operates at the fixed frequency, maintains the zero voltage switching mode during operation and controls the duty cycle of the switches to control the output voltage of the output DC power 142.

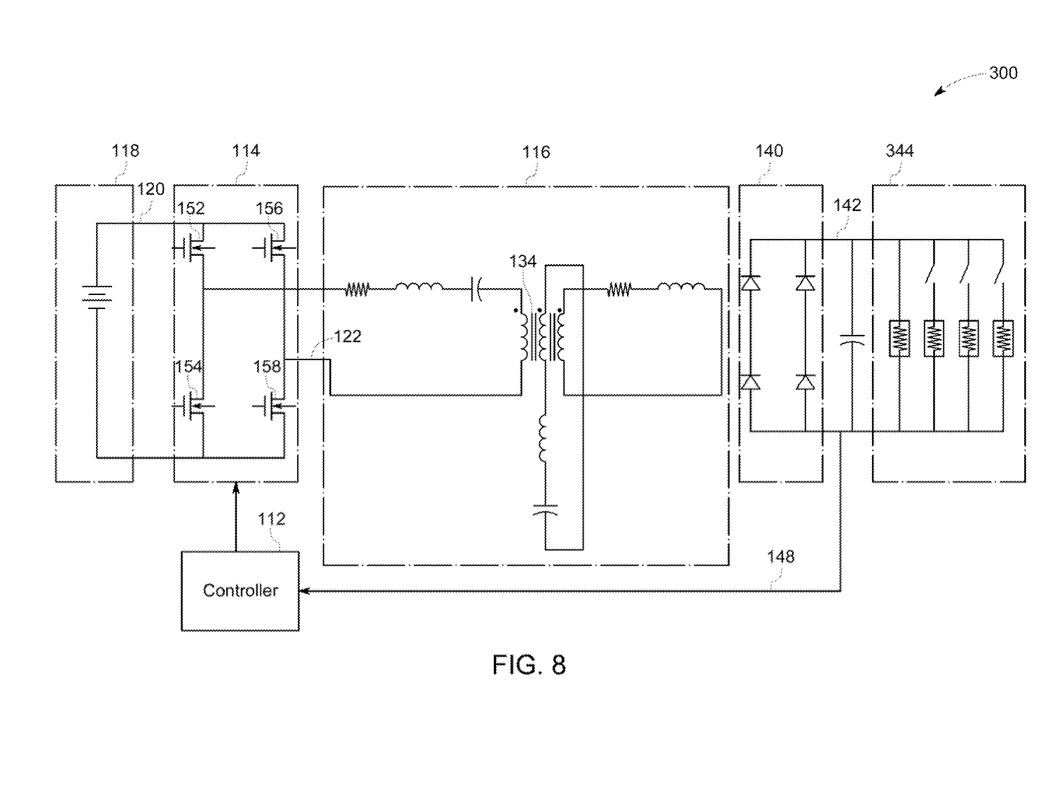

FIG. 8 is a schematic representation of an alternative embodiment 300 of the power conversion system 100 of FIG. 5 comprising a variable load 344 coupled to the power conversion system 300 in accordance with an embodiment of the invention. In one embodiment, the controller 112 performs a simulation wherein the controller 112 conducts a frequency sweep for the variable load 344 coupled to the power conversion system 300. The controller 112 includes the variable load information and based on which the controller 112 identifies respective fixed frequencies for different load values as described in detail above and stores the fixed frequency values for the respective load values during the simulation. Therefore, upon initialization of the operation of the power conversion system 300, a frequency sweep based on the actual load 144 (FIG. 5) that is coupled to the power conversion system 300 is not required and the power conversion system 300 can start its operation directly after identifying the load 144 coupled to the power conversion system 300. This particular embodiment saves the time required for initialization before operation of the power conversion system 300.

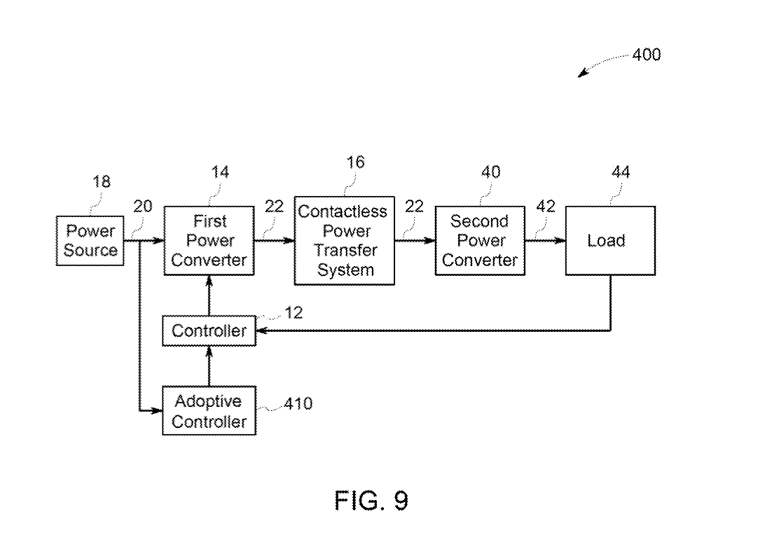

FIG. 9 is a block diagram representation of an alternative embodiment 400 of the power conversion system 10 of FIG. 1 including an adaptive controller 410 coupled to the controller 12 and the power source 18 in accordance with an embodiment of the invention. The power conversion system 400 includes the adaptive controller 410 that receives a signal representative of the input voltage from the power source 18 and controls any variations in the input voltage such that the controller 12 may adjust the control of the switches of the first power converter 14 based on the output voltage of the output power 42.

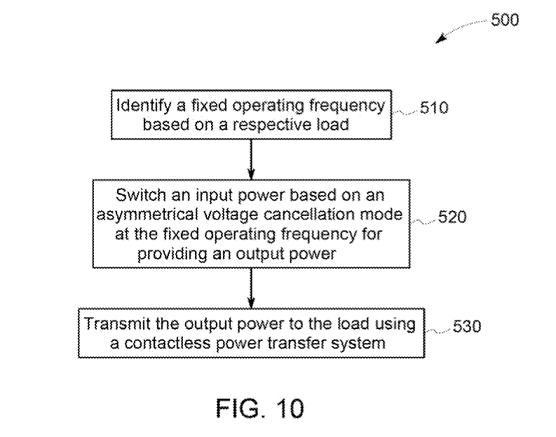

FIG. 10 is a flow chart representing steps involved in a method 500 for controlling an output voltage of an output power of the power conversion system in accordance with an embodiment of the invention. The method 500 includes identifying a fixed operating frequency based on a load coupled to a power conversion system in step 510. In one embodiment identifying the fixed operating frequency based on the load includes conducting a frequency sweep upon initialization of operation for the load. In another embodiment, identifying the fixed operating frequency includes pre-identifying a range of operating frequencies for maintaining a zero voltage switching mode for different loads. The method 500 also includes switching an input power based on an asymmetrical voltage cancellation mode at the fixed operating frequency for providing an output power in step 520. In a specific embodiment, switching the input power based on the asymmetrical voltage cancellation mode includes controlling the output power by controlling a duty cycle of switches during switching the input power. In a more specific embodiment, controlling the output power by controlling the duty cycle comprises receiving a feedback signal representative of the output power. The method 500 further includes transmitting the output power to the load using a contactless power transfer system in step 530. In one embodiment, the method 500 further comprises controlling a variation in the input power by using an adaptive controller.

It is to be understood that a skilled artisan will recognize the interchangeability of various features from different embodiments and that the various features described, as well as other known equivalents for each feature, may be mixed and matched by one of ordinary skill in this art to construct additional systems and techniques in accordance with principles of this disclosure. It is, therefore, to be understood that the appended claims are intended to cover all such modifications and changes as fall within the true spirit of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power conversion system comprising:
a power source configured to provide input power;
a first power converter comprising switches configured to convert the input power to an intermediate converted power;
a controller configured to control the switches of the first power converter based on an asymmetrical voltage cancellation mode wherein the controller is configured to:
operate the first power converter at a fixed operating frequency;
maintain a zero voltage switching mode; and
control a duty cycle of the switches of the first power converter; and
a contactless power transfer system configured to transmit the intermediate converted power to a load; and
a second power converter coupled to the load and configured to convert the intermediate converted power to an output power wherein an output voltage of the output power is controlled by the controller based on the asymmetrical voltage cancellation mode.

2. The power conversion system of claim 1, further comprises an adaptive controller coupled to the controller and configured to control variations in the input power.

3. The power conversion system of claim 1, wherein the output voltage is controlled by the controller by controlling the duty cycle of the switches.

4. The power conversion system of claim 1, wherein the first power converter comprises metal oxide semiconductor field effect transistor switches.

5. The power conversion system of claim 1, wherein the first power converter operates at a switching frequency within a range of about 120 kilohertz to about 160 kilohertz.

6. The power conversion system of claim 1, wherein the first power converter comprises a DC-AC power converter.

7. The power conversion system of claim 1, wherein the second power converter comprises an AC-DC power converter.

8. The power conversion system of claim 1, wherein the input power comprises DC power and the output power comprises AC power.

9. The power conversion system of claim 1, wherein the contactless power transfer system comprises a two coil resonant power transfer system, a three coil resonant power transfer system or a four coil resonant power transfer system.

10. The power conversion system of claim 1, wherein the load comprises a battery provided in an electric vehicle.

11. A method comprising:
identifying a fixed operating frequency based on a load coupled to a power conversion system;
switching an input power based on an asymmetrical voltage cancellation mode at the fixed operating frequency for providing an output power; and
transmitting the output power to the load using a contactless power transfer system.

12. The method of claim 11, further comprising controlling a variation in the input power by using an adaptive controller.

13. The method of claim 11, wherein identifying the fixed operating frequency based on the load comprises conducting a frequency sweep upon initialization of operation for the load.

14. The method of claim 11, wherein identifying the fixed operating frequency comprises pre-identifying a range of operating frequencies for maintaining a zero voltage switching mode for different loads.

15. The method of claim 11, wherein switching the input power based on the asymmetrical voltage cancellation mode comprises controlling the output power by controlling a duty cycle of switches during switching the input power.

16. The method of claim 15, wherein controlling the output power by controlling the duty cycle comprises receiving a feedback signal representative of the output power.
